(19) United States
(12) Patent Application Publication
(10) Pub. No.: US 2024/0140857 A1
(43) Pub. Date: May 2, 2024

(54) MANUFACTURING METHOD FOR CELL-UNIT GLASS SUBSTRATES

(71) Applicant: JOONGWOO M-TECH CO., LTD., Ansan-si (KR)

(72) Inventors: Sung Soo PARK, Yongin-si (KR); Jeong Won OH, Incheon (KR)

(73) Assignee: JOONGWOO M-TECH CO., LTD., Ansan-si (KR)

(21) Appl. No.: 18/379,679

(22) Filed: Oct. 13, 2023

(30) Foreign Application Priority Data
Oct. 28, 2022 (KR) 10-2022-0141158

(51) Int. Cl. C03C 15/00; C03C 23/00

(52) U.S. Cl. CPC C03C 15/00; C03C 23/0025

(57) ABSTRACT

The present invention relates to a cell-unit glass substrate manufacturing method for manufacturing a plurality of cell-unit glass substrates from a glass substrate, wherein the method includes a deformation portion formation step, a protective film lamination step, a first etching step, a second etching step, and a substrate separation step.

### CROSS REFERENCE TO RELATED APPLICATION

The present application claims priority to Korean Patent Application No. 10-2022-0141158, filed Oct. 28, 2022, the entire contents of which is incorporated herein for all purposes by this reference.

### BACKGROUND OF THE INVENTION

### Field of the Invention

The present invention relates to a cell-unit glass substrate manufacturing method, and more particularly, provides a cell-unit glass substrate manufacturing method that reduces the complexity and difficulty of the manufacturing process and does not generate microcracks in the glass panels during the process of separating cell-unit glass substrates from a glass substrate.

The present invention is based on the research findings of “Development of 70 μm ultra-thin tempered glass process technology for 10-inch class foldable device cover window” (project identification number 52967744) conducted under the Small and Medium-sized Enterprise Technology Innovation Development Project led by the Small and Medium-sized Enterprise Technology Development Project of the Ministry of SMEs and Startups.

### DESCRIPTION OF THE RELATED ART

Panels such as displays and cover glasses used in display devices like smartphones are manufactured in the form of glass panels by stacking base substrates made of glass.

To manufacture glass panels used in the display devices, a cutting process in which a glass substrate is partitioned into a plurality of cell-unit glass substrates, and the respective cell-unit glass substrates are cut and separated from the glass substrate subsequently is performed.

In addition, a cutting process in which cell-unit glass substrates are separated from a large master glass sheet is also performed in the manufacturing of irregular-shaped cell substrates or thin-film glass cell substrates.

The conventional manufacturing process of cell-unit glass substrates, whether using mechanical cutting or laser cutting, generates cracks with varying degrees of severity. Since microcracks tend to extend and lead to glass breakage when subjected to tensile stress, post-cutting operations such as polishing or chemical etching are performed to remove the cracks. Additionally, when the cut surface exhibits angular features, giving rise to usability concerns, further processing is performed on the cut surface.

In the case of thin-film glass, the glass is so thin that cutting and shaping the cut surface are challenging. Therefore, it is necessary to stack multiple sheets of glass and process them, which increases the complexity and difficulty of the manufacturing process. In addition, there are further issues of reduced durability and surface defects of the cell-unit glass substrates caused by external forces.

### SUMMARY OF THE INVENTION

An object of the present invention is to provide a solution to the issues in the related art and provide a cell-unit glass substrate manufacturing method that allows the separating of cell-unit glass substrates and cutting of the glass substrates without going through the process of stacking and cutting glass substrates and thus substantially reduces the complexity and difficulty of the manufacturing process of glass panels used in display devices and does not generate microcracks in the glass panels.

A cell-unit glass substrate manufacturing method according to an embodiment of the present invention for resolving the issues described above is a cell-unit glass substrate manufacturing method for manufacturing a plurality of cell-unit glass substrates from a glass substrate. The method includes a deformation portion formation step of forming a deformation portion along a cutting line by emitting a laser beam along the cutting line predefined on the glass substrate, a protective film lamination step of laminating one surface of the glass substrate with a protective film to prevent etching of the one surface of the glass substrate having the deformation portion formed therein, a first etching step of forming a through hole and a through surface in the glass substrate by etching the glass substrate laminated with the protective film to pierce the deformation portion, a second etching step of forming an infiltration hole and an infiltration surface connected to the through hole and the through surface in the glass substrate by infiltrating an etching solution between the protective film lamination surface and the glass substrate once the deformation portion is pierced and the protective film lamination surface is exposed, and a substrate separation step of separating the cell-unit glass substrates from the glass substrate having the through hole, the through surface, the infiltration hole, and the infiltration surface formed therein, in which the protective film lamination surface is etched at a faster rate than the glass substrate in the second etching step and the protective film remains laminated to the one surface of the glass substrate throughout both the first etching step and the second etching step.

In addition, a cell-unit glass substrate manufacturing method according to an embodiment of the present invention for resolving the issues described above is a cell-unit glass substrate manufacturing method for manufacturing a plurality of cell-unit glass substrates from a glass substrate. The method includes a protective film lamination step of laminating one surface of the glass substrate with a protective film to prevent etching of the one surface of the glass substrate, a deformation portion formation step of forming a deformation portion along a cutting line by emitting a laser beam along the cutting line predefined on the glass substrate, a first etching step of forming a through hole and a through surface in the glass substrate by etching the glass substrate laminated with the protective film to pierce the deformation portion, a second etching step of forming an infiltration hole and an infiltration surface connected to the through hole and the through surface in the glass substrate by infiltrating an etching solution between the protective film lamination surface and the glass substrate once the deformation portion is pierced and the protective film lamination surface is exposed, and a substrate separation step of separating the cell-unit glass substrates from the glass substrate having the through hole, the through surface, the infiltration hole, and the infiltration surface formed therein, in which the protective film lamination surface is etched at a faster rate than the glass substrate in the second etching step and the protective film remains laminated to the one surface of the glass substrate throughout both the first etching step and the second etching step.

According to the cell-unit glass substrate manufacturing method according to an embodiment of the present invention, the infiltration speed at which the etching solution infiltrates between the protective film lamination surface and the glass substrate may slow down as the adhesive force between the glass substrates and the protective film becomes stronger.

According to the cell-unit glass substrate manufacturing method according to an embodiment of the present invention, the through surface inclination orientation in which the through surface is formed at an inclination and the infiltration surface inclination orientation in which the infiltration surface is formed at an inclination may be opposite to each other.

According to the cell-unit glass substrate manufacturing method according to an embodiment of the present invention, the portion where the through surface meets the infiltration surface is defined as a crossing portion, and the horizontal length of the through hole from the end of the through hole to the crossing portion may be less than the horizontal length of the infiltration hole from the end of the infiltration hole to the crossing portion while the vertical length of the through hole from the end of the through hole to the crossing portion may be equal to or greater than the vertical length of the infiltration hole from the end of the infiltration hole to the crossing portion.

According to the cell-unit glass substrate manufacturing method according to an embodiment of the present invention, a through surface angle is formed between the through surface and the other surface of the glass substrate and an infiltration surface angle is formed between the infiltration surface and the one surface of the glass substrate laminated with the protective film, in which the through surface angle may be greater than the infiltration surface angle.

According to the cell-unit glass substrate manufacturing method according to an embodiment of the present invention, the through surface may be formed in a straight-line shape while the infiltration surface may be formed in a round shape.

According to the cell-unit glass substrate manufacturing method of the present invention, the cell-unit glass substrates may be cut and the cut surface of the cell-unit glass substrates may be processed smoothly without going through the process of stacking glass substrates so that production time and process may be shortened, product productivity may be increased, and production cost may be reduced.

In addition, according to the cell-unit glass substrate manufacturing method of the present invention, cutting processing is performed only through the first and second etching steps so that defect issues such as cracks do not arise. As a result, cell-unit glass substrates with improved durability and folding properties may be manufactured.

### BRIEF DESCRIPTION OF THE DRAWINGS

FIG. 1 is a flowchart illustrating a cell-unit glass substrate manufacturing method according to an embodiment of the present invention.

FIG. 2 is a schematic view illustrating the deformation portion formation step, the protective film lamination step, the first etching step, and the second etching step in FIG. 1.

FIG. 3 is an exemplary view for describing the substrate separation step in FIG. 1.

FIG. 4 is a view illustrating the horizontal length of a through hole, vertical length of the through hole, horizontal length of an infiltration hole, and vertical length of the infiltration hole according to the cell-unit glass substrate manufacturing method according to an embodiment of the present invention.

FIG. 5 is a view illustrating that the vertical length of the through hole is less than the vertical length of an infiltration hole according to the cell-unit glass substrate manufacturing method according to an embodiment of the present invention.

FIG. 6 is a view illustrating a through surface angle and an infiltration surface angle according to a cell-unit glass substrate manufacturing method according to an embodiment of the present invention.

FIG. 7 is a view illustrating another example of an infiltration surface according to an embodiment of the present invention.

### DETAILED DESCRIPTION OF THE INVENTION

Preferred embodiments of the present invention designed to specifically resolve the above-mentioned issues will be described with reference to the accompanying drawings.

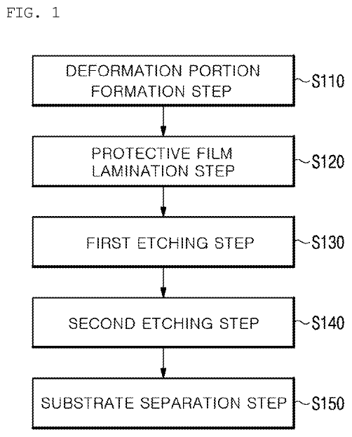

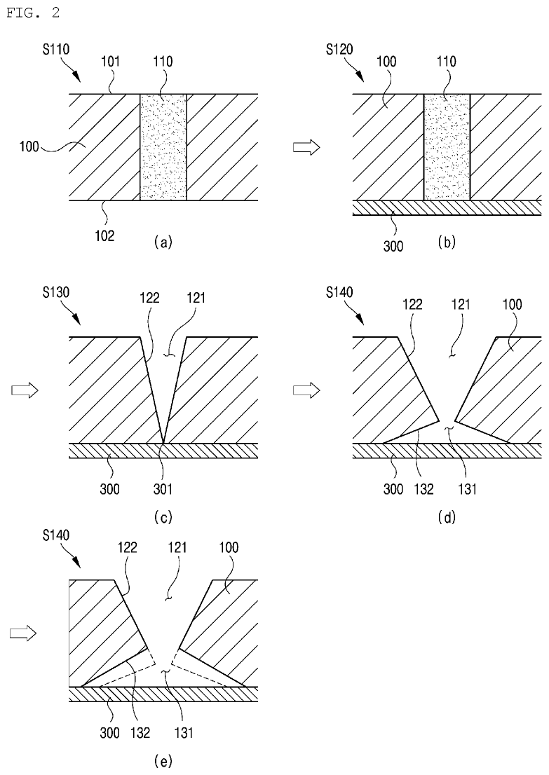

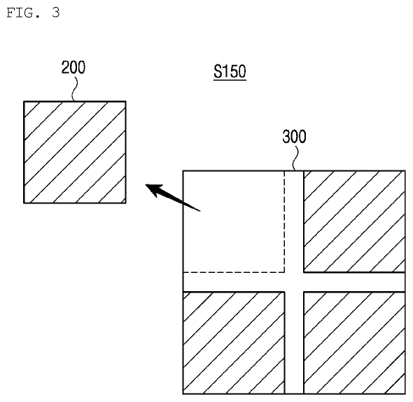

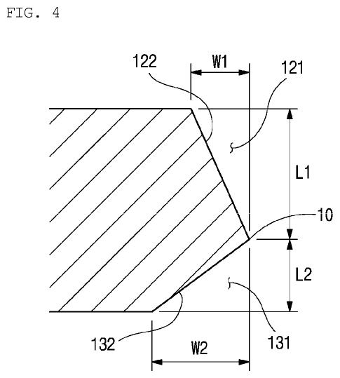

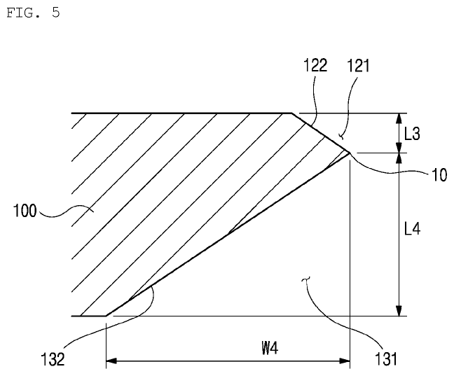

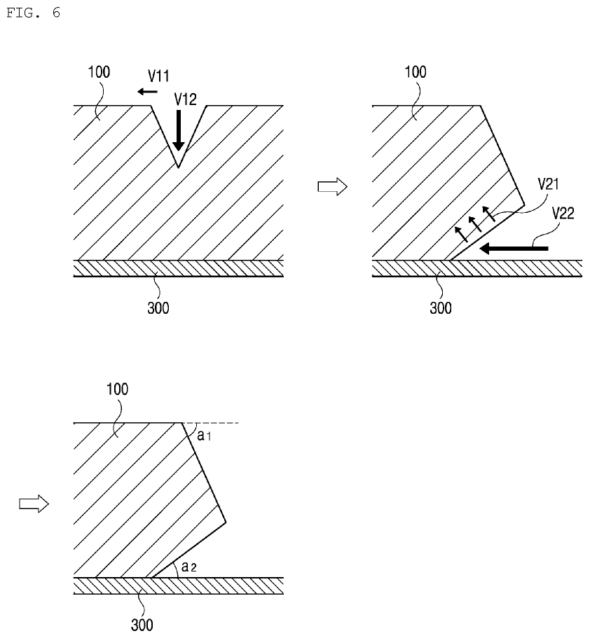

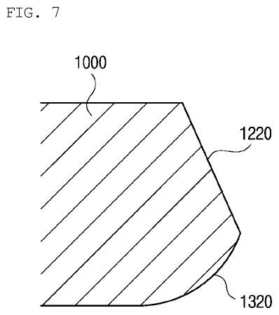

FIG. 1 is a flowchart illustrating a cell-unit glass substrate manufacturing method according to an embodiment of the present invention, FIG. 2 is a view schematically illustrating the deformation portion formation step, the protective film lamination step, the first etching step, and the second etching step in FIG. 1, FIG. 3 is an exemplary view for describing the substrate separation step in FIG. 1, FIG. 4 is a view illustrating the horizontal length of a through hole, the vertical length of the through hole, the horizontal length of an infiltration hole, and the vertical length of the infiltration hole according to the cell-unit glass substrate manufacturing method according to an embodiment of the present invention, FIG. 5 is a view illustrating that the vertical length of the through hole is less than the vertical length of the infiltration hole according to the cell-unit glass substrate manufacturing method according to an embodiment of the present invention, FIG. 6 is a view illustrating a through surface angle and an infiltration surface angle in a cell-unit glass substrate manufacturing method according to an embodiment of the present invention, and FIG. 7 is a view illustrating another example of an infiltration surface according to an embodiment of the present invention.

FIGS. 1 to 3 show that the cell-unit glass substrate manufacturing method according to an embodiment of the present invention involves separating a plurality of cell-unit glass substrates 200 from a glass substrate 100 and includes a deformation portion formation step S110, a protective film lamination step S120, a first etching step S130, a second etching step S140, and a substrate separation step S150.

A deformation portion 110 is formed along a cutting line by emitting a laser beam along the cutting line 20 predefined on the glass substrate 100 in the deformation portion formation step S110 (refer to FIG. 2A).

At this time, the glass substrate 100 serves as a base substrate during a series of processes in which glass panels used in a display device are manufactured in the form of unit-cell glass panels from a glass panel in the form of a mother substrate.

The laser beam used in the deformation portion formation step S110 may have energy intensity not exceeding the ablation threshold of the substrate.

In addition, an ultrashort laser beam including a picosecond pulse laser beam or a femtosecond pulse laser beam may be used as the laser beam. When such an ultrashort laser beam is emitted on a substrate, no molten layer may be generated in areas other than the irradiated area and no material may deteriorate in the surrounding areas.

In other words, when a picosecond pulse laser beam or a femtosecond pulse laser beam is emitted, thermal energy may be effectively applied to the irradiated portion only, and accordingly, the deformation portion 110 formed by the cutting line 20 may be clearly distinguished.

When the glass substrate 100 is irradiated with such a laser beam, the deformation portion 110 may switch from the α-phase to the β-phase. The deformation portion 110 undergoes permanent physical and chemical structural changes through a nonlinear photoionization mechanism induced by an ultrashort laser beam, and as a result of the changes, the material properties such as refractive index may change and the reactivity to etching solutions may improve.

The deformation portion 110 deformed by the ultrashort laser beam may be etched by reacting with alkaline or acidic chemical solutions tens to hundreds of times faster than the undeformed areas in the glass substrate 100. The etching speed may be controlled by numerous variables such as laser energy, pulse duration, repetition rate, wavelength, focal length, scanning speed, chemical solution concentration, and the like.

One surface 102 of the glass substrate 100 is laminated with a protective film 300 to prevent etching of the one surface 102 of the glass substrate 100 having the deformation portion 110 formed therein in the protective film lamination step S120 (refer to FIG. 2B).

The protective film 300 has an adhesive on a protective film lamination surface 301 laminated to the glass substrate 100 and is laminated to one surface 102 of the glass substrate 100 to protect the one surface 102 of the glass substrate 100 from the etching solutions. As described below, the glass substrate 100 is immersed in or sprayed with an etching solution, and the protective film 300 may prevent damage to the one surface 102 of the glass substrate 100 caused by the etching solution in the first etching step S130.

In addition, sidewall etching of the glass substrate 100 is performed and the cell-unit glass substrate 200 may be supported by the protective film 300 in the etching steps after the protective film lamination step S120.

On the other hand, the performing order of the deformation portion formation step S110 and the protective film lamination step S120 may switch. In other words, the protective film lamination step S120 may be performed before the deformation portion formation step S110. This may be the case where the energy intensity of the laser beam is sufficiently low for the protective film 300 to be free from damages induced by the laser beam.

A through hole 121 and a through surface 122 are formed in the glass substrate 110 by etching the glass substrate 100 laminated with the protective film 300 to pierce the deformation portion 110 in the etching step S130 (refer to FIG. 2C).

Chemical etching solutions such as florin (HF), nitric acid (HNO3), potassium hydroxide (KOH), and the like may be used as the etching solution, and the method of etching the glass substrate 100 may include various methods such as immersing the glass substrate 100 in an etching solution, spraying the glass substrate 100 with an etching solution, and the like.

First, etching is performed on the deformation portion 110 deformed by a laser beam being emitted along the cutting line 20. At this time, the one surface 102 of the glass substrate 100 is laminated with the protective film 300 to prevent etching of the one surface by the etching solutions. Etching starts with the deformation portion 110 on the other surface 101 of the glass substrate 100.

As described above, the deformation portion 110 deformed by an ultrashort laser beam may be etched tens to hundreds of times faster than the undeformed areas of the glass substrate 100.

In other words, the other surface 101 of the glass substrate 100 having the deformation portion 110 formed therein may be etched at a relatively faster etching speed in the glass substrate 100. Accordingly, the deformation portion 110 is removed, and the through hole 121 and the through surface 122 may be formed.

At this time, as a result of the difference in etching speeds between the deformation portion 110 and the undeformed areas of the glass substrate 100, the through surface 122 may be formed to incline in the through surface inclination orientation, causing the cross-section of the through hole 121 to narrow downward. At this time, the through surface inclination orientation that narrows the cross-section of the through hole 121 toward the protective film 300 side in the thickness direction of the glass substrate may be created for the through surface 122.

As described above, the deformation portion 110 on the other surface 101 of the glass substrate 100 may be etched at a faster rate than the undeformed areas in the first etching step S130. As the deformation portion 110 is etched and pierced along the cutting line 20 through the first etching step S130, the through hole 121 and the through surface 122 may be formed.

In the second etching step S140, an etching solution infiltrates between the protective film lamination surface 301 and the glass substrate 100 to form an infiltration hole 131 and an infiltration surface 132 connected to the through hole 121 and the through surface 122 in the glass substrate 100 once the deformation portion 110 is pierced and the protective film lamination surface 301 is exposed.

Once the through hole 121 and the through surface 122 are formed and the protective film lamination surface 301 is exposed through the first etching step S130, the etching solution may infiltrate between the protective film lamination surface 301 and the glass substrate 100 while removing the adhesive from the protective film lamination surface 301.

At this time, since the adhesive is removed more rapidly than the glass substrate 100 by the etching solution, the etching solution infiltrating between the protective film lamination surface 301 and the glass substrate 100 keeps infiltrating farther while removing the adhesive first, and the infiltration hole 131 and the infiltration surface 132 may be formed as the one surface 102 of the glass substrate 100 is slowly etched relative to the adhesive (refer to FIG. 2D).

At this time, as the etching between the adhesive and the one surface 102 of the glass substrate advances, the infiltration surface 132 may be formed to incline in an infiltration surface inclination orientation that widens the cross-section of the infiltration hole 131 towards the protective film 300 side in the thickness direction of the glass substrate.

In other words, the infiltration surface inclination orientation and the through surface inclination orientation may be opposite to each other, and the infiltration hole 131 and the infiltration surface 132 are smoothly connected to the through hole 121 and the through surface 122 at the crossing portion 10 where the through surface 122 and the infiltration surface 132 meet.

As described above, as the etching solution infiltrates between the protective film lamination surface 301 and the glass substrate 100 and the one surface 102 of the glass substrate 100 is etched after the adhesive is first removed by the etching solution, the infiltration hole 131 and the infiltration surface 132 connected to the through hole 121 and the through surface 122 may be formed in the glass substrate 100 in the second etching step S140.

On the other hand, FIG. 4 shows that the horizontal length W1 of the through hole from the end of the through hole 121 to the crossing portion 10 may be less than the horizontal length W2 of the infiltration hole from the end of the infiltration hole 131 to the crossing portion 10, while the vertical length L1 of the through hole from the end of the through hole 121 to the crossing portion 10 may be greater than the vertical length L2 of the infiltration hole from the end of the infiltration hole 131 to the crossing portion 10.

First, since the horizontal length W1 of the through hole may represent the length of the other surface of the glass substrate that is etched and removed by the etching solution and the horizontal length W2 of the infiltration hole may represent the length of the one surface 102 of the glass substrate from which the adhesive is etched and removed, the horizontal length W1 of the through hole becomes less than the horizontal length W2 of the infiltration hole as a result of the faster removal of the adhesive than the glass substrate 100 as the second etching step S140 proceeds.

It is preferable to terminate the second etching step S140 when the horizontal length W1 of the through hole becomes less than the horizontal length W2 of the infiltration hole while the vertical length L1 of the through hole is equal to or greater than the vertical length L2 of the infiltration hole.

FIG. 5 shows that the sidewall of the glass substrate 100 may be formed such that the horizontal length W4 of the infiltration hole is excessively long as a result of the relatively fast removal of the adhesive by the etching solution when the second etching step S140 proceeds excessively long for the vertical length L4 of the infiltration hole to be greater than the vertical length L3 of the through hole.

As a result, an excessively pointed cross-section of the glass substrate 100 may cause the glass substrate to break easily by an external impact and the shortened length of the one surface 102 of the glass substrate 100 laminated with the protective film 300 may result in inadequate support for the glass substrate 100 by the protective film 300 and bring about an unintended separation and easy breakage of the cell-unit glass substrate 200 in undesired situations for an operator.

Therefore, by forming the horizontal length W1 of the through hole to be less than the horizontal length W2 of the infiltration hole and the vertical length L1 of the through hole to be equal to or greater than the vertical length L2 of the infiltration hole, the glass substrate 100 subjected to the etching steps may be prevented from easily breaking.

In addition, FIG. 6 shows that a through surface angle a1 is formed between the through surface 122 and the other surface 102 of the glass substrate 100 and that an infiltration surface angle a2 is formed between the infiltration surface 132 and the one surface 101 of the glass substrate 100 laminated with the protective film 300, in which the through surface angle a1 may be greater than the infiltration surface angle a2.

Since the deformation portion 110 of the glass substrate 100 is etched more rapidly than the undeformed area, the through surface angle a1 may be formed to be relatively large as the etching proceeds more rapidly in the thickness direction v12 of the glass substrate 100 in which the deformation portion 110 is formed than in the vertical direction v11.

In contrast, since the adhesive is etched more rapidly than the undeformed area of the glass substrate 100, the infiltration surface angle a2 may be formed to be relatively small as the etching proceeds more rapidly in the horizontal direction v22 between the protective film lamination surface 301 and the glass substrate 100 than in the thickness direction v21 of the glass substrate 100.

Therefore, the sidewall of the glass substrate 100 formed through the first etching step S130 and the second etching step S140 may be formed such that the through surface angle a1 is greater than the infiltration surface angle a2.

On the other hand, the infiltration speed at which the etching solution infiltrates between the protective film lamination surface 301 and the glass substrate 100 may slow down as the adhesive force between the glass substrate 100 and the protective film 300 and acid resistance become stronger.

In other words, the infiltration speed at which the etching solution infiltrates between the protective film lamination surface 301 and the glass substrate 100 may be controlled by adjusting the material properties of the adhesive in the protective film lamination surface 301 such as the adhesive force and acid resistance, and the shape of the infiltration hole 131 and the infiltration surface 132 may be controlled accordingly.

FIG. 3 shows that the cell-unit glass substrate 200 is separated from the glass substrate 100 having the through hole 121, the through surface 122, the infiltration hole 131, and the infiltration surface 132 formed therein in the substrate separation step S150.

The cell-unit glass substrate 200 may be separated from the glass substrate 100 by applying physical pressure along the cutting line 20 in the substrate separation step S150. At this time, a UV or heat-release tape may be used to facilitate separation.

On the other hand, depending on the etching environment, the through surface 122 and the infiltration surface 132 may be formed in a straight-line shape as illustrated in FIGS. 2 to 6, or the through surface 1220 may be formed in a straight-line shape while the infiltration surface 1320 may be formed in a round shape as illustrated in FIG. 7.

According to the cell-unit glass substrate manufacturing method of the present invention configured as described above, executing the steps of deformation portion formation, protective film lamination, first etching, second etching, and substrate separation allows the cutting the cell-unit glass substrates and smooth processing of the cut surface of the cell-unit glass substrates without going through the process of stacking glass substrates, thereby having the effect of shortened production time and process, increased product productivity, and reduced production cost.

In addition, according to the cell-unit glass substrate manufacturing method of the present invention configured as described above, cutting processing is performed only through the first and second etching steps so that defect issues such as cracks do not arise, thereby having the effect of manufacturing cell-unit glass substrates with improved durability and folding property.

The scope of the present invention is not limited to the embodiments and modifications described above and may be implemented in various forms of embodiments within the scope of the attached patent claims. It is understood that various modifications that anyone skilled in the art to which the present invention pertains can make without departing from the gist of the present invention as claimed in the patent claims are within the scope of claims of the present invention.

What is claimed is:

1. A cell-unit glass substrate manufacturing method for manufacturing a plurality of cell-unit glass substrates from a glass substrate, the method comprising:
a deformation portion formation step of forming a deformation portion along a cutting line by emitting a laser beam along the cutting line predefined on the glass substrate;
a protective film lamination step of laminating one surface of the glass substrate with a protective film to prevent etching of the one surface of the glass substrate having the deformation portion formed therein;
a first etching step of forming a through hole and a through surface in the glass substrate by etching the glass substrate laminated with the protective film to pierce the deformation portion;
a second etching step of forming an infiltration hole and an infiltration surface connected to the through hole and the through surface in the glass substrate by infiltrating an etching solution between the protective film lamination surface and the glass substrate once the deformation portion is pierced and the protective film lamination surface is exposed; and
a substrate separation step of separating the cell-unit glass substrates from the glass substrate having the through hole, the through surface, the infiltration hole, and the infiltration surface formed therein, wherein
the protective film lamination surface is etched at a faster rate than the glass substrate in the second etching step and
the protective film remains laminated to the one surface of the glass substrate throughout both the first etching step and the second etching step.

2. A cell-unit glass substrate manufacturing method for manufacturing a plurality of cell-unit glass substrates from a glass substrate, the method comprising:
a protective film lamination step of laminating one surface of the glass substrate with a protective film to prevent etching of the one surface of the glass substrates;
a deformation portion formation step of forming a deformation portion along a cutting line by emitting a laser beam on the cutting line predefined on the glass substrate;
a first etching step of forming a through hole and a through surface in the glass substrate by etching the glass substrate laminated with the protective film to pierce the deformation portion;
a second etching step of forming an infiltration hole and an infiltration surface connected to the through hole and the through surface in the glass substrate by infiltrating an etching solution between the protective film lamination surface and the glass substrate once the deformation portion is pierced and the protective film lamination surface is exposed; and
a substrate separation step of separating the cell-unit glass substrates from the glass substrate having the through hole, the through surface, the infiltration hole, and the infiltration surface formed therein, wherein
the protective film lamination surface is etched at a faster rate than the glass substrate in the second etching step and
the protective film remains laminated to the one surface of the glass substrate throughout both the first etching step and the second etching step.

3. The method of claim 1, wherein the infiltration speed at which the etching solution infiltrates between the protective film lamination surface and the glass substrate slows down as an adhesive force between the glass substrates and the protective film becomes stronger.

4. The method of claim 1, wherein through surface inclination orientation in which the through surface is formed at an inclination and infiltration surface inclination orientation in which the infiltration surface is formed at an inclination are opposite to each other.

5. The method of claim 1, wherein a portion where the through surface meets the infiltration surface is defined as a crossing portion, wherein
the horizontal length of the through hole from the end of the through hole to the crossing portion is less than the horizontal length of the infiltration hole from the end of the infiltration hole to the crossing portion and
the vertical length of the through hole from the end of the through hole to the crossing portion is equal to or greater than the vertical length of the infiltration hole from the end of the infiltration hole to the crossing portion.

6. The method of claim 1, wherein
a through surface angle is formed between the through surface and the other surface of the glass substrate, and
an infiltration surface angle is formed between the infiltration surface and the one surface of the glass substrate laminated with the protective film, wherein
the through surface angle is greater than the infiltration surface angle.

7. The method of claim 1, wherein the through surface is formed in a straight-line shape and the infiltration surface is formed in a round shape.

8. The method of claim 2, wherein the infiltration speed at which the etching solution infiltrates between the protective film lamination surface and the glass substrate slows down as an adhesive force between the glass substrates and the protective film becomes stronger.

9. The method of claim 2, wherein through surface inclination orientation in which the through surface is formed at an inclination and infiltration surface inclination orientation in which the infiltration surface is formed at an inclination are opposite to each other.

10. The method of claim 2, wherein a portion where the through surface meets the infiltration surface is defined as a crossing portion, wherein
the horizontal length of the through hole from the end of the through hole to the crossing portion is less than the horizontal length of the infiltration hole from the end of the infiltration hole to the crossing portion and
the vertical length of the through hole from the end of the through hole to the crossing portion is equal to or greater than the vertical length of the infiltration hole from the end of the infiltration hole to the crossing portion.

11. The method of claim 2, wherein
a through surface angle is formed between the through surface and the other surface of the glass substrate, and
an infiltration surface angle is formed between the infiltration surface and the one surface of the glass substrate laminated with the protective film, wherein
the through surface angle is greater than the infiltration surface angle.

12. The method of claim 2, wherein the through surface is formed in a straight-line shape and the infiltration surface is formed in a round shape.
